(19) United States
(12) Patent Application Publication
(10) Pub. No.: US 2026/0274010 A1
(43) Pub. Date: Sep. 17, 2026

(54) TREAD COMPLIANCE SYSTEM AND METHOD

(71) Applicant: BRIDGESTONE BANDAG, LLC, Nashville, TN (US)

(72) Inventors: Robert G. Otting, Muscatine, IA (US); Chad M. Zeck, Muscatine, IA (US)

(73) Assignee: BRIDGESTONE BANDAG, LLC, Nashville, TN (US)

(21) Appl. No.: 19/168,018

(22) PCT Filed: Mar. 1, 2024
(86) PCT No.: PCT/US2024/017981

§ 371 Date: Sep. 23, 2025

Related U.S. Application Data
(60) Provisional application No. 63/454,380, filed on Mar. 24, 2023.

(51) Int. Cl. B60C 11/24; B60C 11/02; B60C 19/00

(52) U.S. Cl. CPC B60C 11/246; B60C 11/02; B60C 2019/007

(57) ABSTRACT

A system includes a structure configured to support a casing and couple a tread to the casing to create a tire assembly, a sensor configured to measure at least one attribute of the tire assembly, an alarm system configured to provide an alert, and a processing circuit. The processing circuit is configured to receive sensor data from the sensor, and the sensor data is indicative of the at least one attribute of the tire assembly. The processing circuit is further configured to (i) compare the sensor data to a specification data set, the specification data set including a desired attribute of the tire assembly; (ii) determine that the sensor data does not comply with the specification data set; and (iii) cause the alarm system to provide the alert in response to determining that the sensor data does not comply with the specification data set.

### FIELD

The present disclosure relates generally to constructing tires. More specifically, the present disclosure relates to retreading tires.

### BACKGROUND

Tire tread, the portion of a tire on a vehicle that contacts the road, can become worn or abraded in service. Various customers and/or users of vehicle tires may desire vehicle tires to maintain a minimum tread depth. As such, a tire may be removed from a vehicle if the tire tread depth falls below a minimum tread depth.

### SUMMARY

To ensure proper vehicle performance, worn tires should be replaced or repaired. Replacing tires may generally be more expensive than repairing (e.g., retreading) tires. Further, repairing tires may be more environmentally friendly and sustainable than simply replacing the tires. As a result, repairing worn or damaged tires rather than replacing the tires can be desirable.

According to various embodiments, a system is disclosed. The system includes a structure configured to support a casing and couple a tread to the casing to create a tire assembly, a sensor configured to measure at least one attribute of the tire assembly, an alarm system configured to provide an alert, and a processing circuit including a processor coupled to non-transitory memory, wherein the processing circuit is configured to receive sensor data from the sensor, the sensor data being indicative of the at least one attribute of the tire assembly; compare the sensor data to a specification data set, the specification data set including a desired attribute of the tire assembly; determine whether the sensor data complies with the specification data set; and cause the alarm system to provide the alert in response to determining that the sensor data does not comply with the specification data set.

According to various embodiments, the at least one attribute includes a mass of the tire assembly and the desired attribute includes a range of desired tire assembly masses. According to various embodiments, the tread includes at least one of precured rubber or mold cured rubber. According to various embodiments, the alert is provided while the tire assembly is supported by the tire assembly building station. According to various embodiments, the alert is provided after the tread is coupled to the casing. According to various embodiments, the processing circuit is further configured to receive the specification data set from a remote computing system. According to various embodiments, the system includes a user interface coupled to the processing circuit and configured to receive a user input, wherein the specification data set is determined by the processing circuit in response to receiving the user input. According to various embodiments, the user input is indicative of at least one of a customer identity, a brand of the tire assembly, a size of the tire assembly, or a series of casings.

According to various embodiments, a method is disclosed. The method includes coupling a casing to a structure, the structure including at least one sensor, coupling a tread to the casing to form a tire assembly, measuring, via the at least one sensor, at least one attribute of the tire assembly, receiving, via a processing circuit comprising a processor coupled to non-transitory memory, sensor data from the at least one sensor, the sensor data being indicative of the at least one attribute of the tire assembly, comparing, via the processing circuit, the sensor data to a specification data set, the specification data set including a desired attribute of the tire assembly, determining, via the processing circuit, whether the sensor data complies with the specification data set, and causing, via the processing circuit, an alarm system to provide an alert in response to determining non-compliance with the specification data set.

According to various embodiments, the at least one attribute includes a mass of the tire assembly and the desired attribute includes a range of desired tire assembly masses. According to various embodiments, the tread includes a precured tread. According to various embodiments, the alert is provided while the tire assembly is supported by the structure. According to various embodiments, the alert is provided after the tread is coupled to the casing. According to various embodiments, the method includes receiving the specification data set from a remote computing system. According to various embodiments, the method includes receiving a user input via a user interface coupled to the processing circuit, wherein the specification data set is determined by the processing circuit in response to receiving the user input. According to various embodiments, the user input is indicative of at least one of a customer identity, a brand of the tire assembly, a size of the tire assembly, or a series of casings.

This summary is illustrative only and should not be regarded as limiting.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a cross-section view of a tire, according to an example embodiment,

FIG. 2 is a cross-section view of a portion of the tire of FIG. 1,

FIG. 3 is a top view of a precured tire tread, according to an example embodiment,

FIG. 4 is a side view of the precured tire tread of FIG. 3,

FIG. 5 is a cross-section view of the precured tire tread of FIG. 3,

FIG. 6A is a flow diagram of a method of retreading a tire, according to an example embodiment,

FIG. 6B is a schematic diagram of a tire transportation system, according to an example embodiment,

FIG. 7 is a schematic view of a specification compliance check system, according to an example embodiment,

FIG. 8 is a schematic view of a compliance system, according to an example embodiment, and

FIG. 9 is a flow diagram of a method of ensuring a tire assembly is in compliance with the specification, according to an example embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Throughout the specification and claims, the following terms take at least the meanings explicitly associated herein, unless the context dictates otherwise. The meanings identified below do not necessarily limit the terms, but merely provide illustrative examples for the terms. The use of the singular or the plural in a situation is not meant to preclude the alternative such that singular may also include plural instances and plural instances may also include singular instances.

Tires are used in various applications and under a variety of circumstances. Some tires may be designed to withstand the forces of a landing aircraft. Some tires may be designed to provide extra grip on surfaces covered in snow and ice. Some tires may be manufactured to be more suited to be repairable and retreaded.

Generally speaking, a retread tire includes a casing (e.g., a used tire, the main body and structure of the tire assembly, the foundation of the tire assembly, etc.) and a tread coupled to the outer circumference of the casing. Retread tires are used in applications (e.g., aircraft landing gear, tractor trailers, commercial trucks, emergency vehicles, etc.). Therefore a number of casing and tread combinations are possible. For example, a single casing may receive a number of different treads and a single tread may be coupled to a number of different casings. As such, when retreading the tire, precautions are taken to ensure a proper combination of the tread and the casing.

According to various embodiments described herein, a system and method for monitoring tread specification compliance is disclosed. For example, the system and method for monitoring tread specification compliance may be used to ensure a retreaded tire assembly is built to specification. According to various embodiments, the system receives sensor data from a sensor configured to measure at least one attribute of the tire assembly.

According to various embodiments, the system may ensure the retreaded tire assembly is built to specification before the retreaded tire assembly leaves the build station (e.g., before the retreaded tire assembly is cured within the envelope). By doing so, an incorrect casing and tread combination may be resolved at the build station, and may not require additional processing, such as buffing. Thus, ensuring the retreaded tire assembly is built to specification before the retreaded tire assembly leaves the build station may (i) reduce the amount of rework that needs to be performed, (ii) reduce the loss of material involved in reworking a tire assembly, and/or (iii) reduce the loss of time involved in reworking a tire assembly, etc.

According to various examples, a casing for a retread tire is received by a structure configured to support the casings, such as a tire building station. Prior to being received at the building station, the casing may undergo a number of repairs and may further be prepared for retreading (e.g., initial inspection, buffing, repair, etc.). During initial inspection, buffing, repair, or any other process, the tire casing may be supported by a structure. While coupled to a structure, the tire may be supported and elevated such that a tread may be coupled to the casing. For example, a layer of adhesive (e.g., a curable material such as cement or a cement-like substance) may be applied to the outer circumference of the casing. Further, a layer of cushion gum may be applied to the back (e.g., the inside surface) of a new layer of tread, or alternatively, the layer of cushion gum may be applied directly to the tacky surface on the tire casing. According to various embodiments, the cushion gum includes a layer of uncured rubber material. The cushion gum and tread may be applied in combination about the outer circumference of the casing to create a retreaded tire assembly for curing. As an alternative, a length of tire tread may be wrapped around the tire casing with the cushion gum already applied. The cushion gum may form the bond between the tread and the tire casing during curing.

New tread for precured retreading applications is typically molded as a single piece with the tread pattern on one side and an adhesive material such as cement applied to the other side of the tread. Such treads are sometimes referred to as a precured tread. The casing may be trimmed to fit the width of the precured tread. After the new precured tread is applied, a roller pressing process, commonly referred to as stitching, is next performed on the assembly to discharge air from between the tread strip and casing.

Following assembly of the tire casing, cement, cushion gum, and a precured tire tread strip, the overall retreaded tire assembly may be placed within a flexible rubber envelope. An airtight seal may be created between the envelope and the beads of the tire. The entire envelope tire assembly may be placed within a curing chamber and subjected to a vulcanization process that binds the materials together.

According to various examples, once the tire assembly is cured, the tread may be difficult to remove from the casing. For example, the casing may require additional buffing. Therefore, performing a specification compliance check prior to the tire assembly being cured may reduce correction time and expenses if a non-compliant tire assembly is detected.

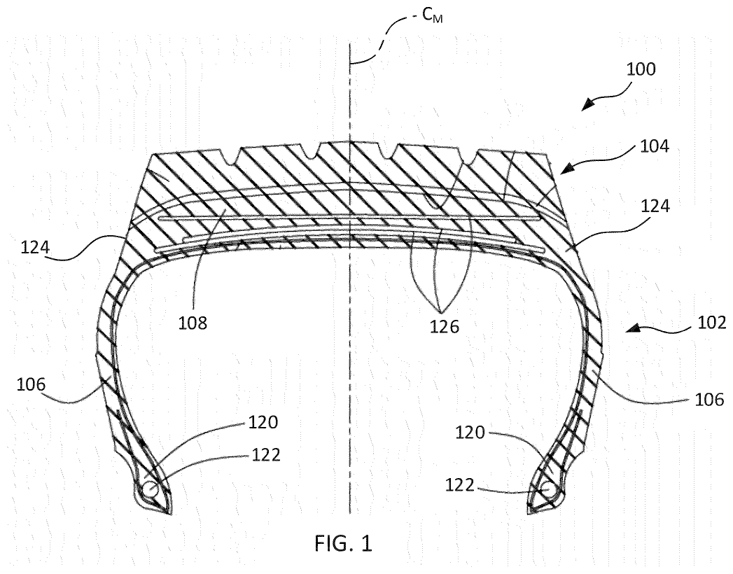

Referring now to FIG. 1, a newly retreaded tire 100 (e.g., an original tire, a new tire, a previously retread or repaired tire, etc.) is shown according to an example embodiment. As shown, the tire 100 includes a tire casing 102 (e.g., tire carcass, etc.) and a tire tread 104. The tire 100 is a radial tire; however, the retreading process discussed throughout this application may be completed on other types of tires, such as bias ply tires.

In the illustrated embodiment, the tire 100 includes a pair of side walls 106 bounded by a generally radial outer wall 108 (e.g., crown) that spans the side walls 106. Each of the side walls 106 extend radially inward from outer wall 108 and terminates at a bead area 120, the bead area 120 structured for mounting on a tire rim. The bead area 120 may be designed in a variety of configurations depending on, for example, tire type, tire size, or rim configuration. In the illustrated embodiment, the bead area 120 may also include a bead bundle 122. The bead bundle 122 may include, for example, metal strands or wires to improve the strength of the bead area 120.

The side walls 106 may include multiple layers, such as a rubber layer, a radial ply, and an inner liner which cooperate to provide the strong and flexible side walls 106. The side walls 106 are joined to the outer wall 108 and the tire tread 104 through a pair of shoulder areas 124. The shoulder areas 124 are contiguous with the side walls 106 and the outer wall 108. In some embodiments, the shoulder areas 124 are contiguous with the tire tread 104. The outer wall 108 may be strengthened by a plurality of belts 126 extending circumferentially about the tire casing 102 within the outer wall 108.

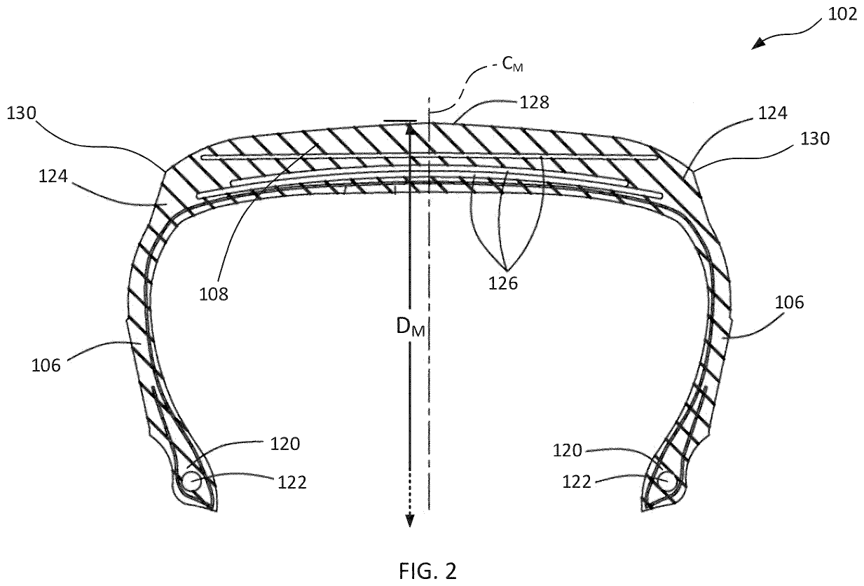

Referring now to FIG. 2, a retread tire 100 with a buffed tread mounting surface 128 is shown, according to an example embodiment. Speaking generally, after the tire tread 104 of the tire 100 wears beyond a certain limit, the tire 100 must either be discarded, re-grooved, or retreaded before it should be used on a vehicle for which it was designed. In cold process retreading, what remains of the tire tread 104 is removed from the tire casing 102 by a buffing machine through a buffing operation. During a buffing operation, the tire tread 104 is ground away from the tire casing 102, leaving a buffed tread mounting surface 128 (e.g., mounting surface, mating surface, bonding surface, curing surface, etc.) on the tire casing 102, as shown, for example, in FIG. 2. The mounting surface 128 extends circumferentially about the tire casing 102 and also extends transversely across the outer wall 108 until it terminates at the shoulder areas 124. When a precured tread assembly (e.g., a PCT assembly) is applied to the mounting surface 128, the interface between the mounting surface 128 and the PCT assembly may be referred to as a bondline. The bondline may have a width equal to the width of the mounting surface 128. In some embodiments, the bondline has a width less than the width of the mounting surface 128 as the PCT assembly applied to the tire casing 102 may have a width less than the width of the mounting surface 128. The bondline extends substantially circumferentially about the tire casing 102 in between the mounting surface 128 and the PCT assembly. Edges of the bondline, shown as edges of the bondline 130 (e.g., a bondline edge), may be visible once a PCT assembly has been applied to the tire casing 102. In some embodiments, the edges of the bondline 130 are defined between the mounting surface 128 and the shoulder areas 124. In some embodiments, the edges of the bondline 130 may be visible after a PCT assembly has been cured to the tire casing 102. In some embodiments, the tire 100 includes the edges of the bondline 130, still visible once the tire 100 is applied to a rim of a vehicle. The edges of the bondline 130 may be parallel to each other (e.g., concentric, equidistant, etc.) and may extend circumferentially about the tire casing 102.

The mounting surface 128 defines a diameter, shown as a casing diameter DM. As shown in FIG. 2, the mounting surface 128 exhibits a curvature between the shoulder areas 124. Thus, the casing diameter DM may be greater proximate a center line CM of the mounting surface 128 when compared to the casing diameter DM proximate the edges of the bondline 130. In some embodiments, the mounting surface 128 is buffed to a slightly rounded (e.g., toroidal) radius extending between the shoulder areas 124. In some embodiments, the mounting surface 128 is flat such that the casing diameter DM is generally the same at all points between the edges of the bondline 130.

Referring still to FIG. 2, the tire 100 is shown after the buffing operation where the tire tread 104 has been removed. In some embodiments, a portion of the tire tread 104 may be left behind on the tire 100, such as if there is a desire to increase a thickness of the outer wall 108 before applying a PCT assembly to the tire casing 102. As shown in FIG. 2, the tire tread 104 has been removed, leaving behind (e.g., exposing, revealing, etc.) the buffed tread mounting surface 128.

After the tire tread 104 is removed and the mounting surface 128 is exposed, a process called skiving and filling may be performed on the tire casing 102. Skiving is the removal of affected material or undesired material from the tire casing 102 prior to making a repair or performing a retread operation. Often, the tire casing 102 accumulates holes, nicks, punctures, or tears due to stones or other sharp objects the tire 100 comes in contact with during use. The affected area is first ground smooth by an appropriate grinding tool and then filled with repair gum (e.g., uncured rubber material). It is necessary to fill the affected areas to the level of the mounting surface 128 (e.g., such that the tread mounting surface 128 remains smooth) to avoid air pockets between the mounting surface 128 and a later-applied PCT assembly. Trapped air between the mounting surface 128 and the PCT assembly may affect a typical retreaded tire (e.g., the tire 100). Following the skiving and filling operation, a building step occurs in which an adhesive (e.g., cushion gum, polyurethane adhesive, rubber cement, liquid adhesive, etc.) and a PCT assembly are applied to (e.g., wrapped around, placed on, stretched over, disposed about, etc.) the mounting surface 128.

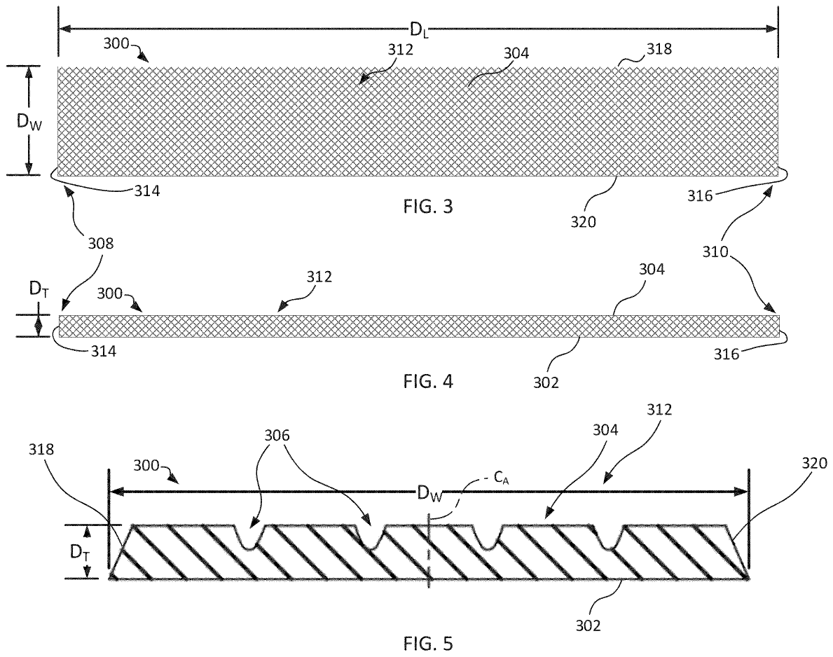

Referring to FIGS. 3-5, a PCT assembly 300 is shown. The PCT assembly 300 may be formed of rubber, natural rubber, synthetic rubber, various polymers, and compounding ingredients, such as such as carbon black, silica, sulfur, anti-degradants, and zinc oxide, or any combination of any of the foregoing materials or others, in order to produce the PCT assembly 300 having the desired end properties. The PCT assembly 300 may be formed in a strip having a tread width D_{W} corresponding to a width of the mounting surface 128 between the shoulder areas 124. The PCT assembly 300 may define a tread length D_{L} corresponding to the casing diameter D_{M} (e.g., the tread length D_{L} may be equal to a circumference of the mounting surface 128, the tread length D_{L} may be equal to the circumference of the mounting surface 128 proximate the center line C_{A}). In some embodiments, the PCT assembly 300 is cut to have a tread length slightly less than (e.g., about ⅛ inches less than) the circumference of the mounting surface 128 such that the PCT assembly 300 may be stretched over the tire casing 102. The PCT assembly 300 may further define a tread thickness, shown as a tread thickness D_{T}. The PCT assembly 300 may include a mounting surface 302 (e.g., generally planar mounting surface, continuous surface, mating surface, binding surface, etc.) and an opposing surface 304 (e.g., generally planar opposing surface, road-contacting surface, tread surface, etc.). The mounting surface 302 may be configured such that the PCT assembly 300 may be applied to the corresponding mounting surface 128 on the tire casing 102. More specifically, the mounting surface 302 may be configured to be cured to the mounting surface 128 to form the tire 100. While the mounting surface 302 is shown as flat in FIGS. 4 and 5, in some embodiments, the PCT assembly 300 may include a mounting surface that is curved in order to match the curvature of the mounting surface 128. The opposing surface 304 may be configured to interface with a road surface and may include a plurality of grooves 306 designed to channel water and provide added traction during certain road and weather conditions.

In some embodiments, the PCT assembly 300 may include a reinforcing fabric layer (e.g., a reinforcing belt, a plurality of reinforcing fabric layers, etc.) positioned within the PCT assembly 300 between the mounting surface 302 and the opposing surface 304. In some embodiments, the PCT assembly 300 includes a reinforcing fabric layer coupled to and extending over the mounting surface 302, the reinforcing fabric layer structured to prevent foreign bodies (e.g., nails, sharp objects, glass, etc.) from penetrating the mounting surface 128 and damaging the tire casing 102. In some embodiments, the PCT assembly 300 includes a plurality of air passages (e.g., air channels) positioned across the mounting surface 302. The plurality of air passages may facilitate the removal of air from between the PCT assembly 300 and the tire casing 102 during a retreading process of the tire 100 (e.g., the tire casing 102). More specifically, the air passages may facilitate the removal of air from between the mounting surface 302 and the mounting surface 128.

The PCT assembly 300 may include a first PCT end 308 and a second PCT end 310. Extending between the first PCT end 308 and the second PCT end 310, and positioned on (e.g., profiled along, molded in, cut in, etc.) the opposing surface 304, may be a tread pattern 312 (e.g., a tread design, a series of treads, a tread pattern repetition, etc.). The tread pattern 312 may include a plurality of lugs, grooves, cuts, sipes, sipe cuts, and similar features. The tread pattern 312 may include the grooves 306.

The first PCT end 308 may include a first PCT end surface 314. The first PCT end surface 314 may be contiguous with both the mounting surface 302 and the opposing surface 304. In some embodiments, the first PCT end surface 314 may be perpendicular to the mounting surface 302. The second PCT end 310 may include a second PCT end surface 316. The second PCT end surface 316 may be contiguous with both the mounting surface 302 and the opposing surface 304. In some embodiments, the second PCT end surface 316 may be perpendicular to the mounting surface 302.

The PCT assembly 300 may further include a first PCT side 318 and a second PCT side 320 opposite the first PCT side 318. The first PCT side 318 may be parallel to the second PCT side 320. In some embodiments, the first PCT side 318 and the second PCT side 320 extend away from the mounting surface 302 in a direction generally toward a center line C_{A} of the PCT assembly 300. When the PCT assembly 300 is applied to the tire casing 102 (e.g., the mounting surface 128), the first PCT side 318 and the second PCT side 320 may be positioned proximate the edges of the bondline 130. The interface between the mounting surface 128 and the mounting surface 302 may be referred to as a bondline. In some embodiments, after the mounting surface 302 is applied to the mounting surface 128, a portion of the mounting surface 128 may still show (e.g., not be covered by the PCT assembly 300) between the edges of the bondline 130 and the shoulder areas 124.

The PCT assembly 300 may be formed by extrusion. In some embodiments, the PCT assembly 300 is formed by molding. The PCT assembly 300 may be formed in a mold such that the tread pattern 312 proximate the first PCT end 308 is continued by the tread pattern 312 proximate the second PCT end 310 such that when the first PCT end 308 and the second PCT end 310 are coupled together, the tread pattern 312 is not interrupted by a break, but continues infinitely around a perimeter of the opposing surface 304.

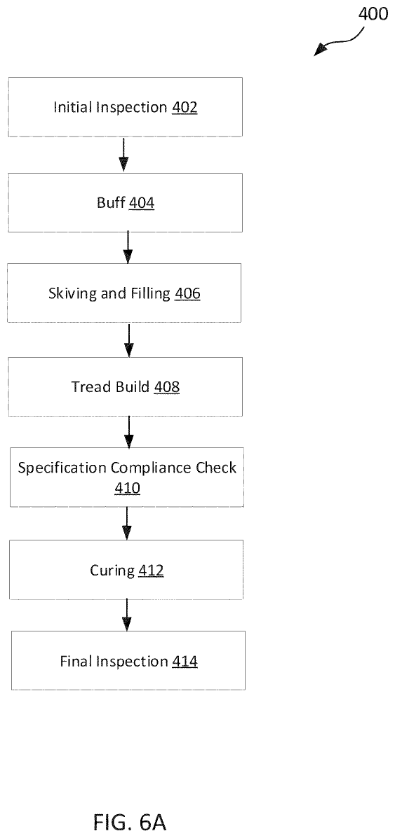

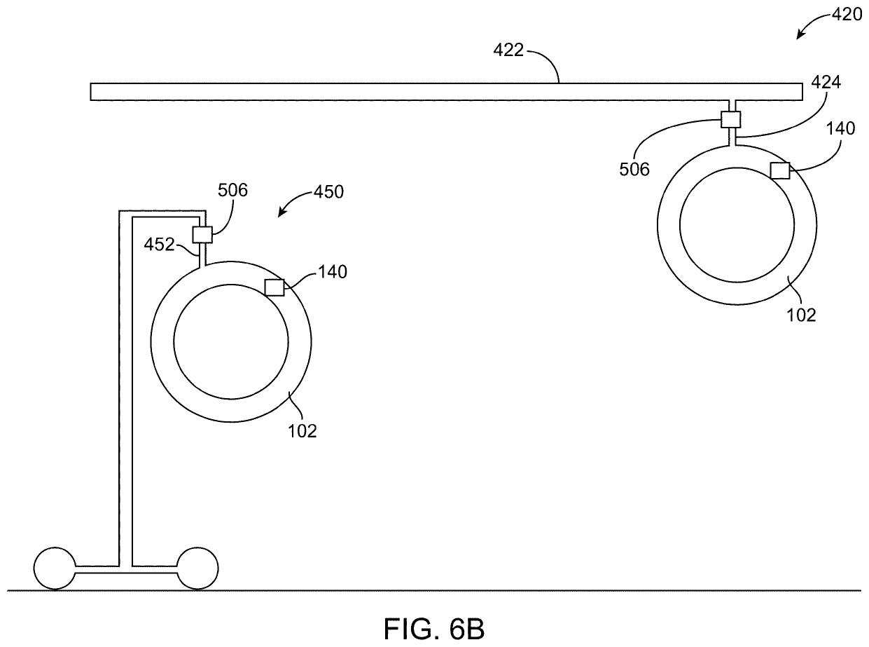

Referring now to FIG. 6A, a method of retreading a tire 400 is shown, according to an example embodiment. The method 400 may be utilized to retread a worn tire, apply a tread to a new casing, and/or create a new tire. The method 400 is exemplary in nature and should not be construed as limiting. For example, it should be appreciated that the processes shown in FIG. 6A need not be performed in the order shown. Further, certain processes may be omitted and additional processes may be included. It should be appreciated that each of the processes described below may be performed autonomously (e.g., using a computer system), manually (e.g., by a technician), or a combination thereof.

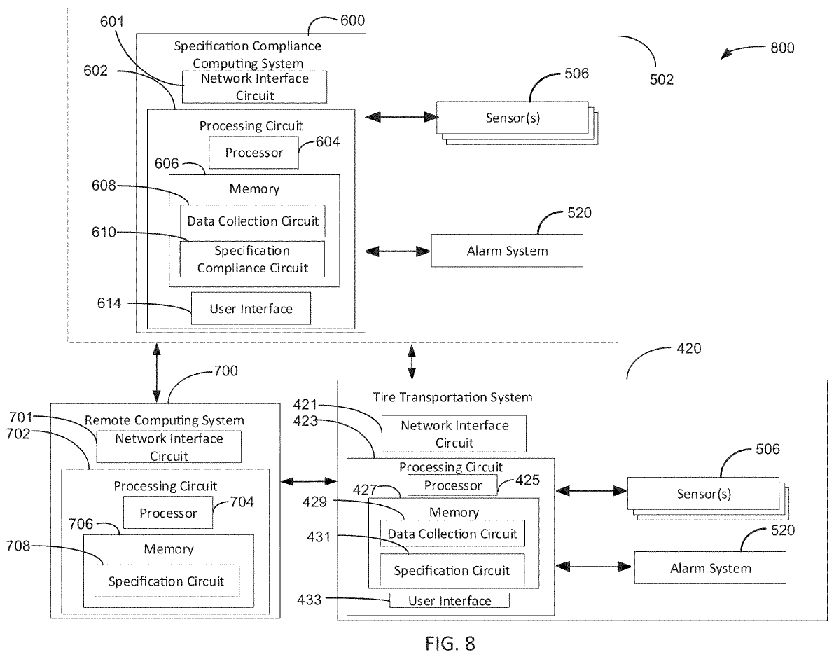

According to various embodiments, the method of retreading a tire 400 may include associating an indicator (e.g., the indicator 140 shown in FIG. 6B) with the tire assembly. The indicator may include one or more attributes of the corresponding tire assembly. For example, the indicator may include details regarding the manufacturer, the year manufactured, the make, the model, the intended treads, retread history, or any other attributes of the tire assembly or the retread tire, the casing, the new tire, etc. According to various embodiments, the indicator includes a code (e.g., a barcode, a QR code, etc.) that, when scanned, is configured to display (or cause a display of) the one or more attributes of the tire to an operator (e.g., via the user interface 614 in FIG. 8). According to various embodiments, the indicator includes a near field communication device (e.g., an RFID tag) that, when scanned, displays or causes a display of the one or more attributes of the tire to an operator (e.g., via the user interface 614 in FIG. 8). According to various embodiments, the near field communication device may be embedded in or affixed to the casing.

At process 402, an initial inspection is performed. For example, an initial inspection may be performed on a worn tire, a new casing, or any other retread tire. As a part of inspection, a technician may determine whether or not the retread tire may be repaired. For example, the retread tire or casing may be inspected (e.g., nail holes, deteriorating rubber, etc.). At process 402, a determination may be made as to whether or not repair is needed (e.g., as a part of process 406).

At process 404, the tire is buffed. For example, the tire may be buffed at a buffing station. As a part of process 404, an outer circumference of the tire (e.g., the tread) is buffed such that some or all of the tread is worn down, thereby exposing the casing. According to various embodiments, the tire may be inflated at the buffing station and subsequently buffed. According to various embodiments, the buffing may be computer aided. For example, one or more sensors may take readings of the tire to ensure uniform buffing and precision accuracy.

At process 406, skiving and filling is performed. For example, if it is determined that a casing needs repair (e.g., as a part of the initial inspection), the casing may be sent to a skive and repair station. As a part of process 406, imperfections in the tire may be subjected to skiving and filling to ensure the casing is properly prepared for a new tread to be applied to the casing.

At process 408, the tread is built onto the casing. For example, the casing may be sent to a tire building station and a tread (e.g., tread including precured rubber, mold cured rubber, or a combination of thereof) may be coupled to the casing. As discussed above, an adhesive (e.g., cushion gum, polyurethane adhesive, rubber cement, liquid adhesive, etc.) may be applied to the casing and/or the tread and the tread (e.g., a PCT assembly) may be coupled to (e.g., wrapped around, placed on, stretched over, disposed about, etc.) the mounting surface of the casing. According to various embodiments, the adhesive is not cured until later in the method 400. Therefore, according to various embodiments, the tread may be removed from the casing without the need for additional buffing. For example, if the tire assembly (e.g., the casing and the tread) does not comply with the desired specification, the tread may be removed such that proper adjustments and altercations may be made.

At process 410, a specification compliance check is performed. The specification compliance check may be utilized to determine whether one or more attributes of the tire assembly falls within a desired range of values. For example, the desired range of values may be defined by a specification (e.g., a manufacturer specification, a customer specification, etc.). As is discussed further below, the specification compliance check may be performed at the tire build station, and therefore, the tire assembly may not need to be moved to perform the specification compliance check. Thus, if a non-compliant tire is detected, proper adjustments may be made at the tire build station, thereby reducing both time and effort required to correct the tire assembly. According to various embodiments, the specification compliance check is performed after the tire is removed from the tire building station and prior to curing. Further, according to various embodiments, the specification compliance check is performed prior to the adhesive being cured. Therefore, the tread may be removed from the casing at the tire building station without the need for additional buffing. For example, if the tire assembly (e.g., the casing and the tread) does not comply with the desired specification, the tread may be removed such that proper adjustments and altercations may be made.

It should be appreciated that a similar specification compliance check may be performed at any point during the process 400. For example, during each of processes 404, 406, 408, 412, and/or 414, the tire may be supported by a structure that includes sensors similar to the sensors included in the tire build station such that a specification compliance check may be performed at any point during the process 400.

At process 412, the tire assembly is cured. For example, after passing the specification compliance check, the tire may be packed inside an envelope and cured in a curing chamber. The curing chamber may cause the adhesive to cure, thereby making it difficult or impossible to remove the tread from the casing without additional buffing.

At process 414, a final inspection is performed. As a part of the final inspection, the crown, the beads, the sidewalls, the interior, and/or any other attributes of the tire assembly may be checked to ensure the tire is satisfactory for its intended use.

Referring now to FIG. 6B, a schematic diagram of a tire transportation system 420 is shown, according to an example embodiment. According to various embodiments, the tire transportation system 420 may be used to transport the tire casing 102 between two or more stations during retreading of a tire 400. For example, the tire transportation system 420 may be used to transport the tire casing 102 to the initial inspection, to the buff station, to the skiving and filling station, to the tread build station, to the specification compliance check, to the cure station, and/or to the final inspection station. In some embodiments, the foregoing order of locations to which the tire casing 102 is transported may be altered, with one or more locations omitted, or alternative or additional locations included. The exemplary embodiments described herein are not limited to any particular order or type of locations to which the tire casing 102 may be transported.

As shown, the tire transportation system 420 includes a transportation rail 422 configured to support a tire casing 102 via a linkage 424. According to various embodiments, the linkage 424 may translate along the rail to transport the tire from one station to another.

As shown, tire transportation system 420 includes one or more sensors 506 coupled to the linkage 424. According to various embodiments, the one or more sensors 506 may include a weight sensor. For example, the weight sensor may be coupled to the linkage 424 such that the weight of the tire (e.g., the tire casing 102, a partial tire assembly, etc.) may be measured while the tire is supported by the linkage 424.

As shown, the tire transportation system 420 includes a tire moving device 450. The tire moving device 450 is configured to receive a tire from the transportation rail 422 and/or load a tire onto the transportation rail 422. As shown, the tire moving device 450 includes a linkage 452 configured to support the tire casing 102. For example, the tire casing 102 may be removed from the transportation rail 422 using the linkage 452.

As shown, tire transportation system 420 includes one or more sensors 506 coupled to the linkage 452. According to various embodiments, the one or more sensors 506 may include a weight sensor. For example, the weight sensor may be coupled to the linkage 452 such that the weight of the tire (e.g., the tire casing 102, a partial tire assembly, etc.) may be measured while the tire is supported by the linkage 452.

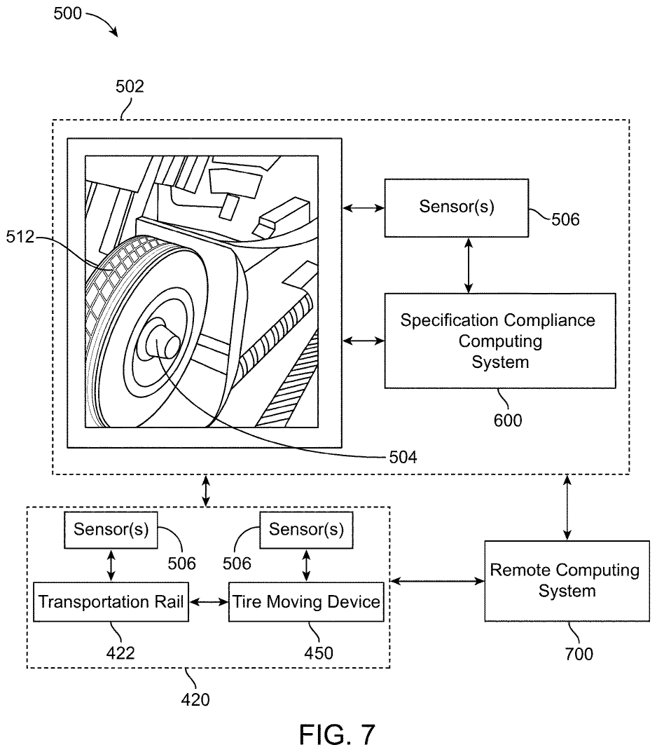

Referring now to FIG. 7, a system for performing a specification compliance check 500 is shown, according to an example embodiment. The system 500 may be utilized to determine whether one or more attributes of the tire assembly falls within a desired range of values. For example, the desired range of values may be defined by a specification (e.g., a manufacturer specification, a customer specification, etc.) (e.g., as a part of process 400 discussed above). It should be appreciated that each of the processes described below may be performed autonomously (e.g., using a computer system), manually (e.g., by a technician), or a combination thereof.

As shown, the system 500 includes a tire building station 502 having a tire support 504 configured to support a tire 512 (e.g., a tire assembly), a tire transportation system 420, one or more sensors 506, and a specification compliance computing system 600. The tire 512 may be the same or similar to any of the other tires described herein (e.g., the tire 100, the tire 102, etc.). As shown, one or more of the sensors 506 and the specification compliance computing system 600 are included in the tire building station 502 and/or the tire transportation system 420, however, according to other embodiments, the one or more sensors 506 and the specification compliance computing system 600 may be separate from the tire building station 502. Further, as shown, a remote computing system 700 is communicably coupled to the tire building station 502 and/or the tire transportation system 420. For example, the remote computing system 700 may be configured to communicate with the specification compliance computing system 600. For example, the remote computing system 700 may provide specification data to the specification compliance computing system 600 such that sensor data (e.g., data recorded by the one or more sensors 506) may be compared to the specification data to ensure the tire 512 is in compliance with the specification.

According to various embodiments, the sensor(s) 506 may include a scanner configured to scan the indicator (e.g., the indicator 140 of FIG. 6B) and provide data embedded in the indicator to the remote computing system 700 such that the remote computing system 700 is able to retrieve the specification information for the tire. According to various embodiments, the specification information is then provided to the tire build station 502 and/or the tire transportation system 420.

As shown, the tire support 504 is configured to support the tire 512 (e.g., a tire assembly including a tread and a casing) within the tire building station 502. As discussed above with respect to FIG. 6B, the transportation rail 422 and the tire moving device 450 are configured to support the tire during and/or between one or more steps of the method 400. The one or more sensors 506 are configured to measure at least one attribute of the tire 512 while the tire 512 is supported by the tire support 504, the transportation rail 422, and/or the tire moving device 450. For example, the one or more sensors 506 may include a sensor (e.g., a weight sensor, a force sensor, etc.) configured to determine a mass or weight of the tire 512. Further, the one or more sensors 506 may include a sensor (e.g., a distance measuring device, a camera, etc.) configured to measure one or more dimensions of the tire 512 (e.g., circumference, diameter, width, tread depth, tread pattern, etc.). Further, the one or more sensors 506 may include a sensor (e.g., a scanner) configured to scan one or more identifiers (e.g., a bar code, a numerical code, a QR code, etc.) located on the casing or tread of the tire 512, embedded within the casing, and/or coupled to the casing or tread of the tire 512.

The readings (e.g., sensor data) taken by the one or more sensors 506 may be provided to the specification compliance computing system 600 such that the specification compliance computing system 600 may determine whether the tire 512 is in compliance with the specification. For example, sensor data may be compared to specification data (e.g., stored within a memory of the specification compliance computing system 600, as provided by the remote computing system 700 in response to scanning an identifier, etc.) to determine whether the sensor data falls within an acceptable range of values as defined by the specification data.

According to various embodiments, the one or more sensors 506 may include a weight sensor. For example, the weight sensor may be coupled to at least one of the tire support 504, the transportation rail 422 and/or the tire moving device 450 such that the weight of the tire may be measured while the tire is supported by at least one of the tire support 504, the transportation rail 422 and/or the tire moving device 450.

Referring now to FIG. 8, a schematic diagram of a compliance system 800 is shown, according to an example embodiment. The compliance system 800 may be utilized to perform a specification compliance check (e.g., the specification compliance check process 410). For example, the compliance system may be utilized to determine whether one or more attributes of the tire assembly falls within a desired range of values. According to various embodiments, the desired range of values may be defined by a specification (e.g., a manufacturer specification, a customer specification, etc.).

As shown, the compliance system 800 includes a specification compliance computing system 600. The specification compliance computing system 600 is communicably coupled to one or more sensors 506, an alarm system 520, the tire transportation system 420, and a remote computing system 700. As shown, the specification compliance computing system 600, the one or more sensors 506, and the alarm system 520 is located within the tire building station 502. However, one or more of the specification compliance computing system 600, the one or more sensors 506, and the alarm system 520 may be located remotely from the tire building station 502. For example, the specification compliance computing system 600 may be located separately from the tire building station 502 while the sensor 506 and/or the alarm system 520 are located within the tire building station 502. In such an embodiment, the specification compliance computing system 600 may still be communicably coupled to the one or more sensors 506, the alarm system 520 and/or the remote computing system 700.

As shown, the compliance system 800 includes one or more sensors 506 configured to record data (e.g., sensor data) associated with a tire assembly (e.g., the tire assembly 512). For example, the one or more sensors 506 may include a sensor (e.g., at least one position sensor, at least one distance sensor, at least one weight sensor, at least one pressure sensor, at least one voltage detector, etc.) configured to measure one or more dimensions of the tire 512 (e.g., circumference, diameter, width, tread depth, tread pattern, etc.). Further, the one or more sensors 506 may include a sensor (e.g., a scanner) configured to scan one or more codes (e.g., a bar code, a numerical code, a QR code, etc.) located on the casing or tread of the tire 512. The readings (e.g., sensor data) taken by the one or more sensors 506 may be provided to the specification compliance computing system 600 such that the specification compliance computing system 600 may determine whether the tire 512 is in compliance with the specification. For example, sensor data may be compared to specification data (e.g., stored within a memory 606 of the specification compliance computing system 600, as provided by the remote computing system 700, etc.) to determine whether the sensor data falls within an acceptable range of values as defined by the specification data.

As shown, the compliance system 800 includes an alarm system 520. The alarm system 520 is configured to provide an alert to an operator of the compliance system 800. For example, the alarm system may provide an audio alert (e.g., sound an alarm), a visual alert (e.g., turning on a light, displaying an alert on a screen, etc.), an audiovisual alert, a haptic alert (e.g., a vibration) to the operator in response to a determination that the tire assembly does not comply with the specification. As shown, the alarm system 520 is communicably coupled to the specification compliance computing system 600 such that the specification compliance computing system 600 may send an alarm signal to the alarm system 520 in response to determining that the tire assembly is not in compliance with the specification. Alternatively or additionally, the alarm system 520 may be integrated with a user interface 614 of the specification compliance computing system 600, as is discussed further below.

In various embodiments, the specification compliance computing system 600 is communicably coupled to sensor(s) 506, such that the data recorded by the sensor(s) 506 may be saved and analyzed. In certain embodiments, the specification compliance computing system 600 includes a network interface circuit 601 configured to enable the specification compliance computing system 600 to exchange information over a network. The network interface circuit 601 can include program logic that facilitates connection of the specification compliance computing system 600 to the network (e.g., a cellular network, Wi-Fi, Bluetooth, radio, etc.). The network interface circuit 601 can support communications between the specification compliance computing system 600 and other systems, such as the remote computing system 700. For example, the network interface circuit 601 can include a modem, a Bluetooth transceiver, a radio-frequency identification (RFID) transceiver, or a near-field communication (NFC) transmitter or any combination thereof. In some embodiments, the network interface circuit 601 includes hardware and machine-readable media sufficient to support communication over one or more channels of data communication.

The specification compliance computing system 600 may include a processing circuit 602 and a user interface 614. The processing circuit 602 may include a processor 604 and a memory 606. The processor 604 may be coupled to the memory 606. The processor 604 may include, for example, an application specific integrated circuit (ASIC), one or more field programmable gate arrays (FPGAs), a group of processing components, or other suitable processing components. The processor 604 is configured to execute computer code or instructions stored in the memory 606 or received from other computer readable media or sources (e.g., cloud storage, other network storage, a remote server, etc.).

The memory 606 may include one or more devices (e.g., memory units, memory devices, storage devices, etc.) for storing data and/or computer code for completing and/or facilitating the various processes described in the present disclosure. The memory 606 may include random access memory (RAM), read-only memory (ROM), hard drive storage, temporary storage, non-volatile memory, flash memory, optical memory, or any other suitable memory for storing software objects and/or computer instructions. The memory 606 may include database components, object code components, script components, or any other type of information structure for supporting the various activities and information structures described in the present disclosure. The memory 606 may be communicably connected to the processor 604 via processing circuit 602 and may include computer code for executing (e.g., by the processor 604) one or more of the processes described herein.

The data collection circuit 608 is configured to collect and store data collected by the sensor(s) 506. For example, the data collection circuit 608 may collect data before, during, and after the tread is coupled to the casing at the tire building station 502, and store the data. Further, the data collection circuit 608 is configured to store operating parameters that the specification compliance computing system 600 may provide to the sensors 506 and/or the alarm system 520 to control the sensors 506 and/or the alarm system 520.

The specification compliance circuit 610 is configured to compare sensor data (e.g., received from the sensor(s) 506) to specification data (e.g., received from the remote computing system, stored in the data collection circuit, stored in the memory 606, etc.). For example, after sensor data is received, the specification compliance circuit 610 may determine whether the sensor data is within an acceptable range as defined by the specification data. If the sensor data is not within an acceptable range, the specification compliance circuit may send an alert signal to the alarm system 520 such that an operator of the tire building station 502 is made aware that the tire assembly is not in compliance with the specification.

The user interface 614 is configured to present information to and receive information from a user. In some embodiments, the user interface 614 includes a display device (e.g., a monitor, a touchscreen, etc.). In some embodiments, the user interface 614 includes an audio device (e.g., a microphone, a speaker, etc.). In various embodiments, the user interface 614 receives alerts from the specification compliance circuit 610 and presents the alerts to an operator of the tire building station 502. For example, the user interface 614 may receive an audible and/or visual alert from the specification compliance circuit 610 and display a graphic on a display device to alert an operator of the current status of the assembly. Further, the operator of the tire building station 502 may input details about the tire assembly (e.g., customer, brand, size, series of casing used, etc.). This information may then be used to determine what specification data should be used by the specification compliance circuit. For example, the user input details may be provided to the remote computing system 700 and the remote computing system 700 may send the corresponding specification data in response. Alternatively or additionally, the user input details may be sent to the data collection circuit 608 such that the data collection circuit 608 may recall the appropriate specification data from the memory and provide the specification data to the specification compliance circuit 610 such that the sensor data may be compared to the specification data.

As shown, the compliance system 800 includes a tire transportation system 420. The tire transportation system 420 is communicably coupled to one or more sensors 506, an alarm system 520, the specification compliance computing system 600, and the remote computing system 700. As shown, the specification compliance computing system 600, the one or more sensors 506, and the alarm system 520 are located within the tire transportation system 420.

In various embodiments, the tire transportation system 420 is communicably coupled to sensor(s) 506, such that the data recorded by the sensor(s) 506 may be saved and analyzed. In certain embodiments, the tire transportation system 420 includes a network interface circuit 421 configured to enable the tire transportation system 420 to exchange information over a network. The network interface circuit 421 can include program logic that facilitates connection of the tire transportation system 420 to the network (e.g., a cellular network, Wi-Fi, Bluetooth, radio, etc.). The network interface circuit 421 can support communications between the tire transportation system 420 and other systems, such as the specification compliance computing system 600 and/or the remote computing system 700. For example, the network interface circuit 421 can include a modem, a Bluetooth transceiver, a radio-frequency identification (RFID) transceiver, or a near-field communication (NFC) transmitter or any combination thereof. In some embodiments, the network interface circuit 421 includes hardware and machine-readable media sufficient to support communication over one or more channels of data communication.

The tire transportation system 420 is configured to include a processing circuit 423 and a user interface 433. The processing circuit 423 may include a processor 425 and a memory 427. The processor 425 may be coupled to the memory 427. Like the processor 604, the processor 425 may include, for example, an application specific integrated circuit (ASIC), one or more field programmable gate arrays (FPGAs), a group of processing components, or other suitable processing components. The processor 425 is configured to execute computer code or instructions stored in the memory 606 or received from other computer readable media or sources (e.g., cloud storage, other network storage, a remote server, etc.).

The memory 427 may include one or more devices (e.g., memory units, memory devices, storage devices, etc.) for storing data and/or computer code for completing and/or facilitating the various processes described in the present disclosure. The memory 606 may include random access memory (RAM), read-only memory (ROM), hard drive storage, temporary storage, non-volatile memory, flash memory, optical memory, or any other suitable memory for storing software objects and/or computer instructions. The memory 606 may include database components, object code components, script components, or any other type of information structure for supporting the various activities and information structures described in the present disclosure. The memory 427 may be communicably connected to the processor 425 via processing circuit 423 and may include computer code for executing (e.g., by the processor 425) one or more of the processes described herein.

The data collection circuit 429 is configured to collect and store data collected by the sensor(s) 506. For example, the data collection circuit 429 may collect data before, during, and after the tread is coupled to the transportation rail 422 and/or the tire transportation device 450, and store the data. Further, the data collection circuit 429 is configured to store operating parameters that the tire transportation system 420 may provide to the sensors 506 and/or the alarm system 520 to control the sensors 506 and/or the alarm system 520.

The specification compliance circuit 431 is configured to compare sensor data (e.g., received from the sensor(s) 506) to specification data (e.g., received from the remote computing system, stored in the data collection circuit, stored in the memory 427, etc.). For example, after sensor data is received, the specification compliance circuit 431 may determine whether the sensor data is within an acceptable range as defined by the specification data. If the sensor data is not within an acceptable range, the specification compliance circuit 431 may send an alert signal to the alarm system 520 such that an operator of the tire transportation system 420 is notified that the tire assembly is not in compliance with the specification.

The user interface 433 is configured to present information to and receive information from a user. In some embodiments, the user interface 433 includes a display device (e.g., a monitor, a touchscreen, etc.). In some embodiments, the user interface 433 includes an audio device (e.g., a microphone, a speaker, etc.). In various embodiments, the user interface 433 receives one or more alerts from the specification compliance circuit 431 and presents the alerts to an operator of the tire transportation system 420. For example, the user interface 433 may receive an audible and/or a visual alert from the specification compliance circuit 431 and display a graphic on a display device to alert an operator of the current status of the assembly. Further, the operator of the tire transportation system 420 may input details about the tire assembly (e.g., customer, brand, size, series of casing used, etc.). This information may then be used to determine which specification data should be used by the specification compliance circuit. For example, the user input details may be provided to the remote computing system 700, and the remote computing system 700 may send the corresponding specification data in response. Alternatively or additionally, the user input details may be sent to the data collection circuit 429 such that the data collection circuit 429 may recall the appropriate specification data from the memory and provide the specification data to the specification compliance circuit 431 such that the sensor data may be compared to the specification data.

The remote computing system 700 is shown to include a processing circuit 702. The processing circuit 702 may include a processor 704 and a memory 706. The processor 704 may be coupled to the memory 706. The processor 704 may include, for example, an application specific integrated circuit (ASIC), one or more field programmable gate arrays (FPGAs), a group of processing components, or other suitable processing components. The processor 704 is configured to execute computer code or instructions stored in the memory 706 or received from other computer readable media or sources (e.g., cloud storage, other network storage, a remote server, etc.).

In certain embodiments, the remote computing system includes a network interface circuit 701 configured to enable the remote computing system 700 to exchange information over a network. The network interface circuit 701 can include program logic that facilitates connection of the remote computing system 700 to the network (e.g., a cellular network, Wi-Fi, Bluetooth, radio, etc.). The network interface circuit 701 can support communications between the remote computing system 700 and other systems, such as the specification compliance computing system 600. For example, the network interface circuit 701 can include a modem, a Bluetooth transceiver, a radio-frequency identification (RFID) transceiver, or a near-field communication (NFC) transmitter or any combination thereof. In some embodiments, the network interface circuit 701 includes hardware and machine-readable media sufficient to support communication over one or more channels of data communication.

According to various embodiments, the remote computing system 700 may be communicably coupled to multiple specification compliance computing systems 600 and/or the tire transportation system 420. In this example embodiment, the remote computing system 700 may receive sensor data from a plurality of specification compliance computing systems 600 and/or the tire transportation system 420. The sensor data may be utilized to update the specification data. For example, the specification data may define a range of acceptable values of sensor data for a specific series of casing. The range of acceptable values may be updated based on the sensor data. For example, the range of acceptable values may be define an upper limit and a lower limit for the sensor data. The upper limit and the lower limit may be an upper percentile and a lower percentile of empirical data recorded by the sensor(s), respectively, of the various sensor data readings that are associated with that customer, brand, and/or series of casing.

The memory 706 may include one or more devices (e.g., memory units, memory devices, storage devices, etc.) for storing data and/or computer code for completing and/or facilitating the various processes described in the present disclosure. The memory 706 may include random access memory (RAM), read-only memory (ROM), hard drive storage, temporary storage, non-volatile memory, flash memory, optical memory, or any other suitable memory for storing software objects and/or computer instructions. The memory 706 may include database components, object code components, script components, or any other type of information structure for supporting the various activities and information structures described in the present disclosure. The memory 706 may be communicably connected to the processor 704 via processing circuit 702 and may include computer code for executing (e.g., by the processor 704) one or more of the processes described herein.

The specification circuit 708 is configured to collect and store specification data. For example, the specification data may be received directly from customers and/or suppliers of the tires and/or casings. According to various embodiments, the specification circuit 708 is configured to collect and store sensor data collected by the sensor(s) 506.

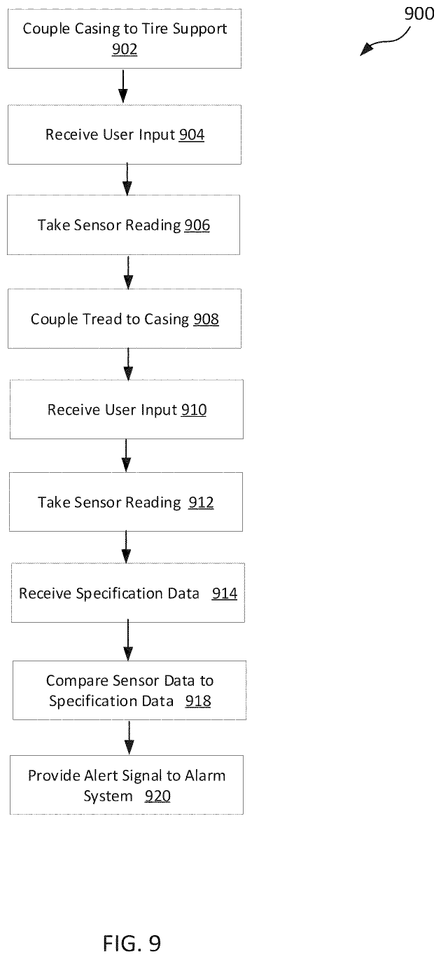

Referring now to FIG. 9, a method of ensuring a tire assembly is in compliance with the specification 900 is shown according to an example embodiment. The method 900 may include some or all of the process 408 and the process 410 discussed above with respect to FIG. 6A. The method 900 is exemplary in nature and should not be construed as limiting. For example, it should be appreciated that the processes shown in FIG. 9 need not be performed in the order shown. Further, certain processes may be omitted and additional processes may be included. It should be appreciated that each of the processes described below may be performed autonomously (e.g., using a computer system), manually (e.g., by a technician), or a combination thereof.

At process 902, a casing is coupled to a tire support. For example, the casing may be couple to the tire support as a part of retreading the tire. According to various embodiments, the casing may be inflated as a part of process 402.

At process 904, a user input may be received. For example, an operator at the tire building station may utilize a user interface to indicate the type of casing that is coupled to the tire support. For example, the operator may input a customer, a brand, a size, a weight, an age, or any other attribute of the casing, tire assembly being built, and/or the intended tread into a specification compliance computing system. The user input may be stored in the memory of the specification compliance computing system and may be leveraged to determine the specification data that corresponds with the identified casing, tire assembly, and/or the intended tread. It should be appreciated that, according to various embodiments, process 904 may be omitted.

At process 906, one or more sensor readings may be taken. For example, one or more sensors may take one or more readings of the casing and provide the corresponding sensor data associated with the casing to the specification compliance computing system. According to various embodiments, this sensor data may be leveraged to automatically determine the type of casing that is coupled to the tire support. For example, the weight or the mass of the casing may be measured using one or more sensors. The measured weight or mass may be compared to a specification database that includes specification data of a plurality of casing types. The measured weight or mass may then be matched to a weight or mass in the specification database to determine the type of casing being utilized. According to another example embodiment, two or more types of sensor data (e.g., weight, mass, inner diameter, outer diameter, etc.) may be utilized to determine which type of casing is coupled to the tire support. For example, both the weight and inner diameter may be referenced against the specification database to determine the type of casing. According to certain embodiments, the casing may include a scan-able code (e.g., a bar code, a QR code, an RFID chip, etc.) that identifies the type of casing. In this example embodiment, the one or more sensors may scan the scan-able code to determine the type of casing that is coupled to the tire support.

At process 908, a tread is coupled to the casing. For example, a precured tread may be coupled to the casing that is supported by the tire support. According to various embodiments, process 908 may include applying an adhesive to the tread and/or the casing, as discussed further above.

At process 910, another user input may be received. For example, an operator at the tire building station may utilize a user interface to indicate the type of tread and/or tire assembly that is being built at the tire building station. For example, the operator may input a customer, a brand, a size, a weight, an age, or any other attribute of the tread and/or the tire assembly into a specification compliance computing system. The user input may be stored in the memory of the specification compliance computing system and may be leveraged to determine the specification data that corresponds with the identified tread and/or tire assembly. It should be appreciated that, according to various embodiments, process 910 may be omitted.

According to various embodiments, process 910 includes manually inputting sensor data. For example, in the example embodiment described above, a weight sensor may be integrated into a lift used to move the tire assembly after the tread is coupled to the casing. The operator may then read the weight from the weight sensor and input the weight into the specification compliance computing system.

At process 912, one or more sensor readings may be taken. For example, one or more sensors may take one or more readings of the tire assembly and provide the corresponding sensor data associated with the tire assembly to the specification compliance computing system. The sensor data may correspond to one or more attributes of the tire assembly. According to various embodiments, this sensor data may be leveraged to automatically determine if the tire assembly is in compliance with the specification, as is discussed further herein.

At process 914, specification data is received. For example, the specification compliance computing system may receive the specification data from the remote computing system. Alternatively or additionally, the specification data may be retrieved from the memory of the specification compliance computing system.

Process 914 may further include determining the correct specification data. According to various embodiments, the first user input, the first sensor readings, the second user input, and/or the second sensor readings may be leveraged to determine the correct specification data. For example, the operator may input the desired customer, brand, size, and/or series of casing, and the corresponding specification data may be provided to the specification compliance computing system in response. Alternatively or additionally, the sensor data may be leveraged to determine the proper specification data to be used. For example, one or more attributes (e.g., weight, size, etc.) of the casing may be determined at process 906. The attributes may be referenced against a specification database that includes attributes of a plurality of different types of casings. The type of casing may then be identified by matching the one or more measured attributes to the one or more attributes in the specification database. For example, the specification database may define a range of the typical attributes of the casing and if the measured attribute(s) fall within that range, the type of casing may be identified.

Once the casing is identified (e.g., using a user input from process 904, using sensor data from process 906, any combination thereof, etc.), the corresponding specification data may be identified. For example, according to various embodiments, the identified casing may be configured to receive a limited number of types of treads to create a tire assembly, and therefore, a limited number of tire assembly combinations exist. According to various embodiments, a user input may be requested by the specification compliance system. The user input may require the operator to identify the type of tire assembly being built, and in response, the specification data for that type of tire assembly may be provided to the specification compliance circuit. Alternatively or additionally, the specification data corresponding with each of the tire assembly combinations may be provided to the specification compliance circuit.

At process 918, sensor data is compared to specification data to determine if the tire assembly is within an acceptable range as defined by the specification data. For example, sensor data collected at process 912 and corresponding to one or more attributes of the tire assembly may be compared to the specification data to determine if the sensor data is within an acceptable range as defined by the specification. For example, the weight or the mass of the tire assembly may be measured using one or more sensors at process 912. The measured weight or mass may be compared to the specification data received at process 914. According to another example embodiment, two or more types of sensor data (e.g., weight, mass, inner diameter, outer diameter, etc.) may be compared to the specification data to further determine if the tire assembly complies with the specification.

At process 920, an alert signal may be provided to the alarm system. For example, the specification compliance computing system may provide an alert signal to the alarm system in response to determining that the sensor data does not fall within an acceptable range as defined by the specification data. According to various embodiments, the alert signal is provided while the tire assembly is supported by the tire assembly building station. The alarm system may provide an alert to the operator of the tire build station that the tire is not in compliance such that the operator may remove the tread before the tire assembly is cured, thereby reducing correction time and efforts.

It should be appreciated that the foregoing operations for determining whether a tire assembly is in compliance with one or more specification may be modified while remaining within the scope of the present disclosure. Such modified operation(s) may be performed at any point during the tire retread process (e.g., during any one of the operations according to method 400 described above). For example, rather than coupling the casing to the tire support device at process 902, the casing and/or tire assembly may be coupled to the transportation rail 422 and/or the tire transportation device 450, such that sensor data may be obtained.

According to various embodiments, a method of ensuring a tire assembly is in compliance with the specification may be performed during the initial inspection (e.g., process 402). For example, the sensor(s) 506 on the tire transportation system 420 may be used to scan an indicator and/or take weight data of the tire during initial inspection. According to various embodiments, the weight of the tire assembly may be utilized to determine one or more attributes of the casing and/or the history of the casing by comparing the weight data to specification data.

According to various embodiments, a method of ensuring a tire assembly is in compliance with the specification may be performed before buffing (e.g., process 404). For example, the sensor(s) 506 may be used to obtain weight data, which may be compared to specification data to determine how much tread (e.g., by weight) is remaining on the casing. For example, the weight of the tire may be compared to the specification data for the respective casing and the difference may correspond to the amount of tread remaining on the casing. According to various embodiments, a method of ensuring a tire assembly is in compliance with the specification may be performed after buffing (e.g., process 404). For example, the sensor(s) 506 may be used to take weight data, which may be compared to specification data to determine if a sufficient amount of tread has been removed from the tire during the buffing process. For example, if the weight data indicates the weight of the tire assembly of the buffed tire is greater than a minimum threshold (e.g., as determined by the specification data), an operator may be alerted that additional buffing is required.

According to various embodiments, a method of ensuring a tire assembly is in compliance with the specification may be performed after the skiving and filling process (e.g., process 406.) For example, the sensor(s) 506 may be used to take weight data, which may be compared to specification data to determine if a sufficient amount of repair material has been added to the tire. Further, the weight data may be stored (e.g., in a data collection circuit) and provided to the remote computing system to update the weight of the specific casing for future testing. As utilized herein with respect to numerical ranges, the terms “approximately,” “about,” “substantially,” and similar terms generally mean for example +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, variations in the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or any processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration.

In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

1. A system comprising:
a structure configured to support a casing of a tire assembly;
a sensor configured to measure at least one attribute of the tire assembly;
an alarm system configured to provide an alert; and
a processing circuit comprising a processor coupled to non-transitory memory, wherein the processing circuit is configured to:
receive sensor data from the sensor, the sensor data being indicative of the at least one attribute of the tire assembly;
compare the sensor data to a specification data set, the specification data set including a target attribute of the tire assembly;
determine whether the sensor data complies with the specification data set; and
cause the alarm system to provide the alert in response to determining non-compliance with the specification data set.

2. The system of claim 1, wherein the at least one attribute includes a mass of the tire assembly and the target attribute includes a range of desired tire assembly masses.

3. The system of claim 1, wherein the tire assembly includes a tread, and wherein the tread includes at least one of precured rubber or mold cured rubber.

4. The system of claim 1, wherein the alert is provided while the tire assembly is supported by the structure.

5. The system of claim 1, wherein the tire assembly includes a tread, and wherein the alert is provided after the tread is coupled to the casing.

6. The system of claim 1, wherein the processing circuit is further configured to receive the specification data set from a remote computing system.

7. The system of claim 1, further comprising a user interface coupled to the processing circuit and configured to receive a user input, wherein the specification data set is determined by the processing circuit in response to receiving the user input.

8. The system of claim 7, wherein the user input is indicative of at least one of a customer identity, a brand of the tire assembly, a size of the tire assembly, or a series of casings.

9. A method of constructing a tire, the method comprising:
coupling a casing to a structure, the structure including at least one sensor;
coupling a tread to the casing to form a tire assembly;
measuring, via the at least one sensor, at least one attribute of the tire assembly;
receiving, via a processing circuit, sensor data from the at least one sensor, the sensor data being indicative of the at least one attribute of the tire assembly;
comparing, via the processing circuit, the sensor data to a specification data set, the specification data set;
determining, via the processing circuit, whether the sensor data complies with the specification data set; and
causing, via the processing circuit, an alarm system to provide an alert in response to determining non-compliance with the specification data set.

10. The method of claim 9, wherein the at least one attribute includes a mass of the tire assembly and comparing the sensor data to the specification data set includes comparing the sensor data to at least one desired attribute in the specification data set, the at least one desired attribute including a range of desired tire assembly masses.

11. The method of claim 9, wherein the tread includes a precured tread.

12. The method of claim 9, wherein the alert is provided while the tire assembly is supported by the structure.

13. The method of claim 9, wherein the alert is provided after the tread is coupled to the casing.

14. The method of claim 9, further comprising receiving the specification data set from a remote computing system.

15. The method of claim 9, further comprising receiving a user input via a user interface coupled to the processing circuit, wherein the specification data set is determined by the processing circuit in response to receiving the user input.

16. The method of claim 15, wherein the user input is indicative of at least one of a customer identity, a brand of the tire assembly, a size of the tire assembly, or a series of casings

17. A system comprising:
one or more processing circuits configured to:
receive sensor data indicative of at least one attribute of a tire assembly;
compare the sensor data to a specification data set including a target attribute of the tire assembly;
determine whether the sensor data complies with the specification data set; and
cause an alarm system to provide an alert in response to determining non-compliance with the specification data set.

18. The system of claim 17, wherein the at least one attribute includes a mass of the tire assembly and the target attribute includes a range of desired tire assembly masses.

19. The system of claim 17, wherein the one or more processing circuits includes at least one of (i) a first processing circuit on the system or (ii) a second processing circuit remote from the system.

20. The system of claim 19, wherein the one or more processing circuits includes the first processing circuit on the system and the second processing circuit, and wherein the first processing circuit is configured to receive the specification data set from the second processing circuit.
